(19) United States
(12) Patent Application Publication
(10) Pub. No.: US 2008/0103904 A1
(43) Pub. Date: May 1, 2008

(54) Fine-Grained Criteria Targeting

(76) Inventors: Patrick Julien, Mascouche (CA); Bryan Mongeau, Montreal (CA); Daniel Parisien, Montreal (CA)

Correspondence Address: TECHNOLOGY LAW GROUP, LLC, 2215 West State Street, BOISE, ID, 83702, US

(21) Appl. No.: 11/828,215

(22) Filed: Jul. 25, 2007

Related U.S. Application Data
(60) Provisional application No. 60/820,589, filed on Jul. 27, 2006.
(60) Provisional application No. 60/820,591, filed on Jul. 27, 2006.
(60) Provisional application No. 60/820,594, filed on Jul. 27, 2006.
(60) Provisional application No. 60/820,595, filed on Jul. 27, 2006.
(60) Provisional application No. 60/820,598, filed on Jul. 27, 2006.

(51) Int. Cl. G06Q 30/00

(52) U.S. Cl. 705/14

(57) ABSTRACT

A system and method for efficiently querying a network of logical digital advertising units by creating a list of named criteria meaningful for the particular network and then associate relevant criteria with each unit. A simplified query system is disclosed having two selection lists, one for choosing criteria of interest and the other for choosing an appropriate boolean operator, which allows sophisticated queries to be submitted with a few clicks of the mouse if the network is set up as disclosed herein.

### CROSS-REFERENCE TO RELATED APPLICATIONS

This application claims priority under 35 U.S.C. §119(e) to U.S. Provisional Application No. 60/820,589, filed Jul. 27, 2006, entitled “Network Control Time Spans,” U.S. Provisional Application No. 60/820,591, filed Jul. 27, 2006, entitled “Broadcast Day,” U.S. Provisional Application No. 60/820,594, filed Jul. 27, 2006, entitled “Campaign Performance Report,” U.S. Provisional Application No. 60/820,595, filed Jul. 27, 2006, entitled “Day Part Frame Criteria”, and U.S. Provisional Application No. 60/820,598, filed Jul. 27, 2006, entitled “Fine-Grained Criteria Targeting,” the entire contents of each are hereby incorporated by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention relates to enhancements to a digital signage system. More particularly, the invention relates to a system and method of a more efficient system to map campaign requirements of advertisers with appropriate display units and display frames on a large network of digital signs.

Consumer product advertising is rapidly migrating from traditional media, such as billboards, newspapers, magazines, mailings, television and radio, to a medium of networks of digital signs. A digital sign network typically includes a number of display units, where each display unit typically is divided into multiple frames, and each frame is able to display an advertising message. The digital paradigm is vastly superior to traditional signage systems because content can be changed instantly and inexpensively, allowing a single display unit to service multiple advertisers. This is often a “win-win” situation for both consumers and advertisers. Consumers generally find changing content more interesting. The digital paradigm benefits advertisers who can “time share” valuable advertising space and venues with other advertisers, giving them more affordable access to formally cost prohibitive advertising platforms.

A major benefit of a digital signage network contrasted with traditional billboards is that advertising content can be changed quickly and inexpensively in the digital signage arena. Furthermore, a network of digital signs typically includes venues with varying demographics (even for the same locations at different days and times). To maximize advertising value, advertisers generally want to match their advertising message with appropriate audiences. For example, advertising feminine hygiene products to men or hip-hop music products to senior citizens is an inefficient use of advertising resources, wasting both valuable advertising space, the budget of the advertisers, and the time of members of the adverting audience.

A modern computer-based digital signage system with a large inventory of signage venue and related infrastructure, can be viewed as a database. Well known database techniques could be used to query such a system. Unfortunately, the users of digital advertising systems—typically advertising and business professionals—generally lack the database expertise necessary to form effective queries particularly to analyze available inventory in a large digital signage network. What is needed is a system that accommodates advertising professionals and provides a simple way for such professionals lacking database expertise to formulate meaningful queries to help them efficiently match advertising content with advertising venues.

### BRIEF SUMMARY OF THE INVENTION

The present invention provides new and unobvious benefits over the prior art in a three step process. In one embodiment of the invention, digital signage experts create a list of named criteria for a signage system. Criteria names typically include location information, such as “airport” or “mall”, as well as demographic information such as “teens” or “seniors”. The invention works with either digital display units or with display frames of digital display units wherein a frame typically also has an associated schedule, so that multiple frames can be defined for the same screen real estate at different times. Digital display units and frames of such units are hereafter referred to generally as advertising message renderers.

The invention further provides that once a list of named criteria is chosen for a particular digital signage network, an appropriate subset of the list of named criteria, referred to as “renderer criteria”, is then assigned to each advertising message renderer. The present invention does not constrain any digital signage network to be constrained to a predetermined list of possible criteria, instead, the criteria and the associated criteria names are typically chosen by advertising professionals, and can be configured dynamically as the networks grows and as advertisers communicate their needs to the signage providers.

The invention further provides for a query system, capable of receiving criteria based queries. Queries are typically boolean expressions where each term is a named criteria. “Term” herein is used to mean any operand of a boolean expression. For example, if the named criteria list included “adults” and “children”, a query expression might be “adult AND children”, where “AND” is a boolean operator, and “adults”, ”children” are terms. During a query of the network, the terms are evaluated in the context of each advertising renderer, and if criteria is found in the associated criteria of a particular display unit or display frame, then that term would evaluate to TRUE. The query engine returns a list of renderers for which the campaign query, when evaluated as a boolean expression in the context of each renderer, evaluates to TRUE. Thus in a network of display frames, if the campaign query was “adults” OR “children”, the query system would return every unit have a criteria of “adults” and, in addition, would return units having the criteria of “children”.

To allow advertising professionals to avoid directly forming boolean expressions, the invention provides for display two selection lists to help form queries. The first selection list shows a list of all of the available criteria on the network, wherein the user can make multiple selections to identify criteria of interest. A second selection list allows the user to select “AND” or “OR” as the boolean operator, although in one embodiment, “AND” is labeled “match all” and “OR” is labeled “match any”.

The invention works particularly well when display units are logically divided up into time-specific frames, with criteria associated with each frame, and with criteria that is chosen to accurately reflect the demographics of the anticipated viewers at the times the frame is operational.

### BRIEF DESCRIPTION OF SEVERAL VIEWS OF THE DRAWINGS

FIG. 1 is a block diagram showing generally one embodiment of the present invention using simplified criteria for illustration purposes.

FIG. 2 is a block diagram illustrating in more detail how named criteria might be assigned to a network of digital display units, and how the corresponding criteria might appear to a user using the simplified criteria of FIG. 1.

FIG. 3 is a block diagram illustrating in more detail how named criteria might be assigned to a more advanced network of digital signage deploying “broadcast day” topology, showing frames instead of the simpler display unit paradigm of FIG. 2.

### DETAILED DESCRIPTION OF THE INVENTION

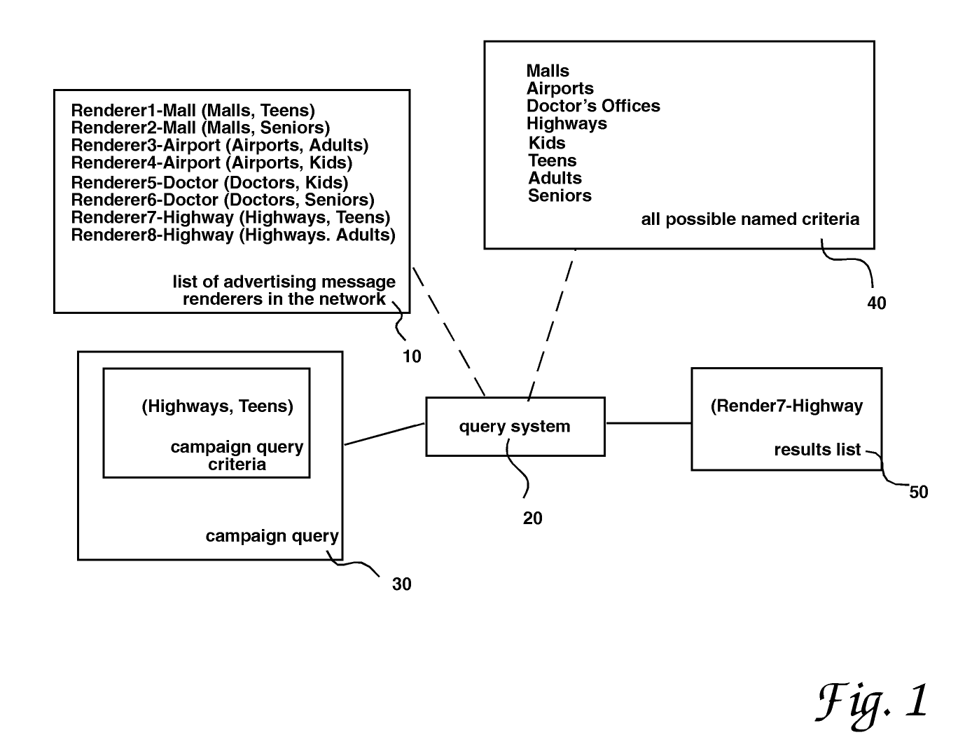

FIG. 1 shows generally one embodiment of the present invention. Referring to FIG. 1, a digital signage system typically includes a number of digital display units or frames, which are illustrated generally as a list of advertising message renderers 10. The universe of all possible named criteria 40 is illustrated. For this simplified network, the following criteria have been named: Malls, Airports, Doctor's Offices, Highways, Teens, Adults, and Seniors. Note that some of the criteria describes the location of the renderer, while other named criteria describes the anticipated audience. A real network would typically have many more named criteria, and new named criteria can be added dynamically as new renderers are added to the network. FIG. 1 also includes an illustrative campaign query based on the named criteria “Highways” and “Teens”. Typically queries will return any renderer matching any named criteria, but the selection process can be coerced to return renderers having all the specified named criteria. The list of advertising message renderers 10, for each renderer, also lists the named criteria assigned to each renderer. For example, for the system of FIG. 1, Renderer7-Highway is presumably a digital billboard on a highway frequented by teenagers, and thus the named criteria “Highways” and “Teens” has been assigned to Renderer7-Highway.

FIG. 1 also illustrates a query system 20, which receives a campaign query 30 and returns a results list 50 of renderers consistent with the query. A campaign query 30 is a query based on the goals and demographics of a specified advertising campaign. The invention does not specifically limit the nature of the query, but the preferred embodiment teaches a simple selection technique that when deployed in a signage system with carefully designed named criteria, provides sophisticated searching and matching capabilities despite its apparent simplicity. A major benefit of the preferred embodiment of the present invention is the avoidance of complex queries and boolean expressions. Thus, in the example of FIG. 1, digital signage designers have set up the network of 8 venues for digital advertisings message as shown in the list of advertising message renderers 10.

In the example illustrated in FIG. 1, the systems designers, presumably with input from their advertising customers, have determined a list of all possible named criteria 40 for their network and have assigned the name criteria to the appropriate renderers. When servicing an advertising customer, an advertising campaign is deployed, and campaign queries 30 are formed to determine what inventory of digital advertising space is available that is consistent with the desired campaign. In this example, presumably the advertiser has a product and corresponding digital advertising targeted at teens who drive an automobile. The query system 20 processes the campaign query 30 and in this example, returns results 50 that include the venue denoted in FIG. 1 as Renderer7-Highway, which would likely be a billboard on a highway frequented by teenagers. Appropriate advertising space could then be purchased, and the advertising campaign would proceed with advertisements being rendered on carefully chosen display units to address a carefully targeted audience.

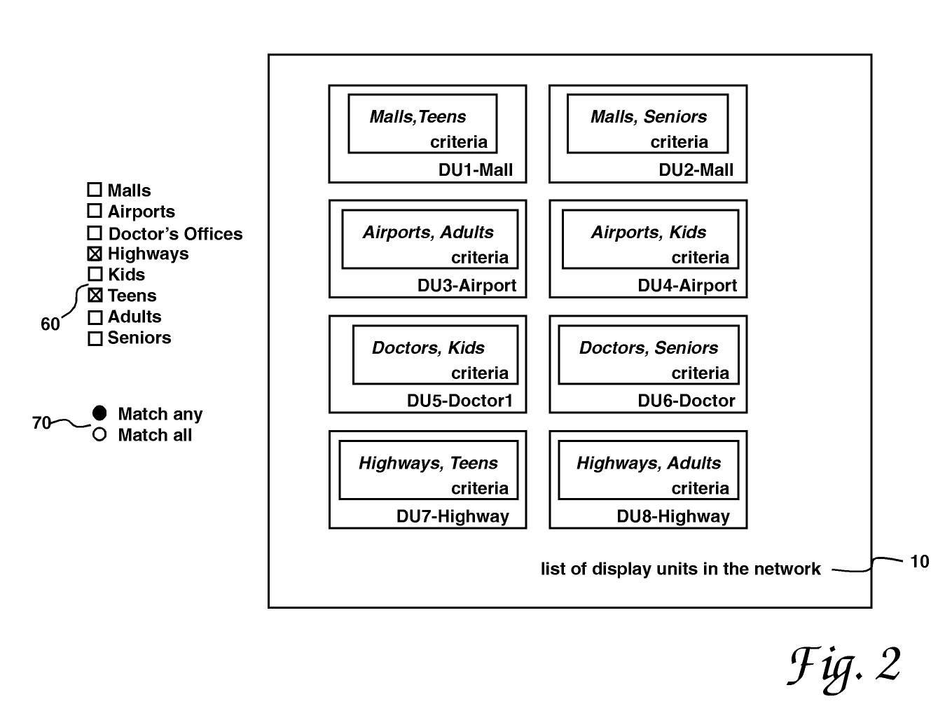

FIG. 2 shows an analogous situation where the all of the renderers 20 are digital display units. Shown also in FIG. 2 is a typical simple criteria selection list 60 showing both “Highways” and “Teens” as being selected. Also shown in FIG. 2 is a second simple selection box 70 showing “Match any” is selected, meaning, for a given display unit, if any of the selected named criteria are present, the unit will be returned in the results list 50. The alternative “Match all” requires that all selected criteria be present in the named criteria of a display unit before that display unit will be returned in the results list 50.

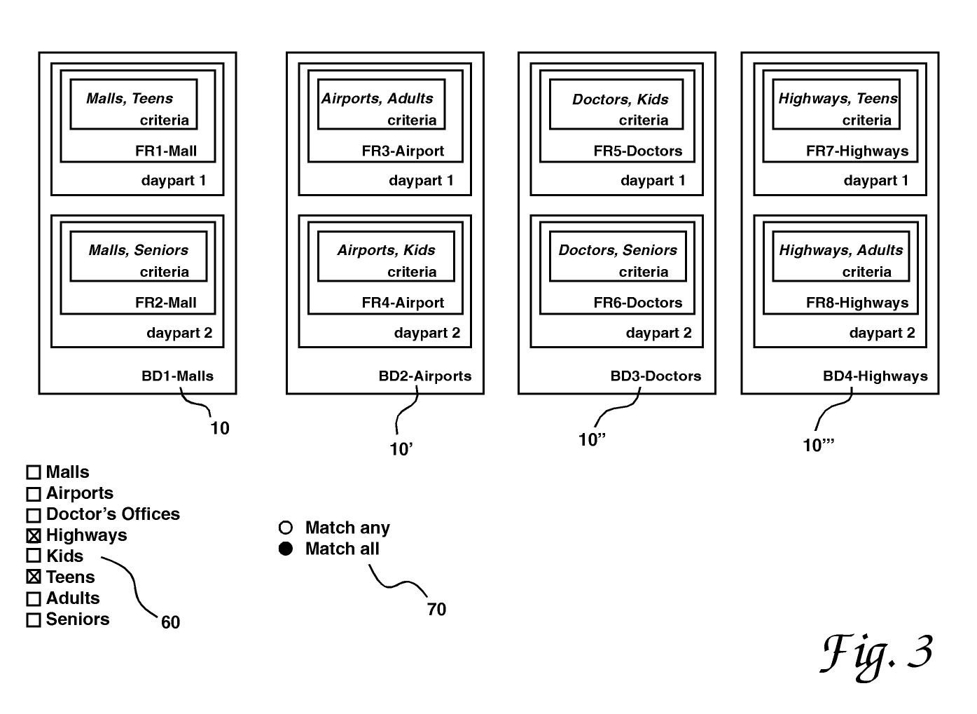

FIG. 3 show an analogous example in a more sophisticated system deploying “Broadcast Days” technology, the subject of copending application referenced above. Briefly, in a “Broadcast Days” paradigm, display units are partitioned by both display unit real estate and also partitioned by time. The term “display frame” is used to denote a physical subset of a digital display unit suitable for display an advertising message. The term “day part” is used to denote a particular time span associated with a display unit where the display can be subdivided into a frame scheme suitable for that time span, and furthermore, different named criteria can be associated with each particular frame for each particular time period. This novel scheme allows digital signage systems designers to take advantage of the important fact that a single advertising venue can have different demographics at different times. In our example, suppose a particular highway normal has most adult traffic, but during certain hours just before a high school day starts and a high school day ends, the same highway is then flooded with teenage traffic.

FIG. 3 shows a digital signage system of only 4 display units, but each display unit has been subdivided into two day parts, each having a single frame. This is a very simple example. In general there are many more day parts and often many more frames per day part. When the example campaign query 30 is executed by selecting the desired named criteria selection list 60 and the selecting the boolean operator “or” by selecting “Match any” from the operator selection list 70, the query system 20 will return FR7-Highways in the results list 50 and the advertising campaign 30 will deploy ads on the billboard on the highway, but only during the times frequented by teenagers.

The preferred embodiment limits the boolean operators to two, namely “logical or” (labeled “Match any”) and “logical and” (labeled “Match all”). The invention allows other operators to be deployed; indeed a full boolean expression could be deployed. However, in the preferred embodiment, the boolean operator list, by design, is purposely limited. Note that the results required by more robust boolean expressions can usually be better achieved by adding named criteria. For example, suppose an advertiser wants “Adults” but not “Seniors”. This cannot be queried in our simple example. In the preferred embodiment, system designers would be required to design an appropriately named criteria (perhaps “Adults ages 18-65”), and then assign it to suitable display units or frames. The advantages of the design of the preferred embodiment is the complexity required to formulate a sophisticated query is shifted from advertising professionals to the digital signage system design experts. This design results in an overall better system for the signage business and a very easy and fast query system for advertising professionals.

This description is provided for the purposes of illustration, not limitation. As one skilled in the art will appreciate, there are a number of alternate embodiments of the present invention not shown, that are in the spirit of the invention. The invention is only limited by the claims as set forth below.

We claim:

1. A system for querying a network of electronic displays comprising:
a first list of named criteria,
a plurality of advertising message renderers, each advertising message renderer capable of displaying at least one advertising message, each advertising message renderer further includes associated renderer criteria, the associated renderer criteria further comprises a second list of named criteria wherein the second list of named criteria is a subset of the first list of named criteria,
a query system capable of receiving a campaign query, wherein, when said campaign query is presented to said query system, the query system returns a results list having zero or more advertising message renderers wherein said campaign query is evaluated as a boolean expression in the context of each first advertising message renderer, and said first advertising message renderer is returned in said results lists if and only if said boolean expression evaluates to true when evaluated in the context of said first advertising message renderer.

2. The system of claim 1 further comprising:
a first selection list, the first selection list is comprised of members of said first list of named criteria,
wherein said boolean expression further comprises one term for each criteria selected from said first selection list,
wherein, when said boolean expression is executed in the context of a second advertising message renderer, for each term of said boolean expression that is a member of the first list of named criteria, said term evaluates to a logical TRUE if and only if said named criteria corresponding to said term is a member of the second list of named criteria of the associated renderer criteria of said second advertising message renderer.

3. The system of claim 2 further comprising:
a second selection list, the second selection list is comprised of a list of binary boolean operators, the second selection list is configured to allow the selection of exactly one binary boolean operator from the second selection list, wherein said terms of said boolean expression are separated by the selected boolean operator.

4. The system of claim 3, wherein the selection list of boolean operators includes a logical AND operator and a logical OR operator.

5. The system of claim 4, wherein the logical AND operator, when present, is labeled “all” and the logical OR operator, when present, is labeled “any”.

6. The system of claim 5, wherein said names of named criteria for each advertising message renderer are chosen to accurately reflect the demographics of anticipated viewers of said advertising message renderer.

7. The system of claim 4, wherein said names of named criteria for each advertising message renderer are chosen to accurately reflect the demographics of anticipated viewers of said advertising message renderer.

8. The system of claim 3, wherein said names of named criteria for each advertising message renderer are chosen to accurately reflect the demographics of anticipated viewers of said advertising message renderer.

9. The system of claim 2, wherein said names of named criteria for each advertising message renderer are chosen to accurately reflect the demographics of anticipated viewers of said advertising message renderer.

10. The system of claim 1 further comprising:
a second selection list, the second selection list is comprised of a list of binary boolean operators, the second selection list is configured to allow the selection of exactly one binary boolean operator from the second selection list, wherein said terms of said boolean expression are separated by the selected boolean operator.

11. The system of claim 10, wherein the selection list of boolean operators includes a logical AND operator and a logical OR operator.

12. The system of claim 11, wherein the logical AND operator, when present, is labeled “all” and the logical OR operator, when present, is labeled “any”.

13. The system of claim 12, wherein said names of named criteria for each advertising message renderer are chosen to accurately reflect the demographics of anticipated viewers of said advertising message renderer.

14. The system of claim 11, wherein said names of named criteria for each advertising message renderer are chosen to accurately reflect the demographics of anticipated viewers of said advertising message renderer.

15. The system of claim 10, wherein said names of named criteria for each advertising message renderer are chosen to accurately reflect the demographics of anticipated viewers of said advertising message renderer.

16. The system of claim 1, wherein said names of named criteria for each advertising message renderer are chosen to accurately reflect the demographics of anticipated viewers of said advertising message renderer.

17. A method for querying a network of electronic displays comprising the steps of:
associating a first list of named criteria with the network,
associating a plurality of advertising message renderers with the network, each advertising message renderer capable of displaying at least one advertising message, each advertising message renderer further includes associated renderer criteria, the associated renderer criteria further comprises a second list of named criteria wherein the second list of named criteria is a subset of the first list of named criteria,
associating a query system capable of receiving a campaign query with the network, wherein, when said campaign query is presented to said query system, the query system returns a results list having zero or more advertising message renderers wherein said campaign query is evaluated as a boolean expression in the context of each first advertising message renderer, and said first advertising message renderer is returned in said results lists if and only if said boolean expression evaluates to true when evaluated in the context of said first advertising message renderer.

18. The method of claim 17 further comprising the steps of:
associating a first selection list with the network, the first selection list is comprised of members of said first list of named criteria,
wherein said boolean expression further comprises one term for each criteria selected from said first selection list,
wherein, when said boolean expression is executed in the context of a second advertising message renderer, for each term of said boolean expression that is a member of the first list of named criteria, said term evaluates to a logical TRUE if and only if said named criteria corresponding to said term is a member of the second list of named criteria of the associated renderer criteria of said second advertising message renderer.

19. The method of claim 18 further comprising the steps of:
associating a second selection list with the network, the second selection list is comprised of a list of binary boolean operators, the second selection list is configured to allow the selection of exactly one binary boolean operator from the second selection list, wherein said terms of said boolean expression are separated by the selected boolean operator.

20. The method of claim 19, wherein the selection list of boolean operators includes a logical AND operator and a logical OR operator.

21. The method of claim 20, wherein the logical AND operator, when present, is labeled “all” and the logical OR operator, when present, is labeled “any”.

22. The method of claim 21, wherein said names of named criteria for each advertising message renderer are chosen to accurately reflect the demographics of anticipated viewers of said advertising message renderer.

23. The method of claim 20, wherein said names of named criteria for each advertising message renderer are chosen to accurately reflect the demographics of anticipated viewers of said advertising message renderer.

24. The method of claim 19, wherein said names of named criteria for each advertising message renderer are chosen to accurately reflect the demographics of anticipated viewers of said advertising message renderer.

25. The method of claim 18, wherein said names of named criteria for each advertising message renderer are chosen to accurately reflect the demographics of anticipated viewers of said advertising message renderer.

26. The method of claim 17 further comprising the steps of:
associating a second selection list with the network, the second selection list is comprised of a list of binary boolean operators, the second selection list is configured to allow the selection of exactly one binary boolean operator from the second selection list, wherein said terms of said boolean expression are separated by the selected boolean operator.

27. The method of claim 26, wherein the selection list of boolean operators includes a logical AND operator and a logical OR operator.

28. The method of claim 27, wherein the logical AND operator, when present, is labeled “all” and the logical OR operator, when present, is labeled “any”.

29. The method of claim 28, wherein said names of named criteria for each advertising message renderer are chosen to accurately reflect the demographics of anticipated viewers of said advertising message renderer.

30. The method of claim 27, wherein said names of named criteria for each advertising message renderer are chosen to accurately reflect the demographics of anticipated viewers of said advertising message renderer.

31. The method of claim 26, wherein said names of named criteria for each advertising message renderer are chosen to accurately reflect the demographics of anticipated viewers of said advertising message renderer.

32. The method of claim 17, wherein said names of named criteria for each advertising message renderer are chosen to accurately reflect the demographics of anticipated viewers of said advertising message renderer.
